(19) United States
(12) Patent Application Publication
(10) Pub. No.: US 2022/0414580 A1
(43) Pub. Date: Dec. 29, 2022

(54) SALES TALENT DEVELOPMENT SUPPORT SYSTEM, SALES TALENT DEVELOPMENT SUPPORT METHOD, AND SALES TALENT DEVELOPMENT SUPPORT PROGRAM

(71) Applicant: R-Square & Company Inc., Tokyo (JP)

(72) Inventor: Takahiro Yamashita, Tokyo (JP)

(21) Appl. No.: 17/780,555

(22) PCT Filed: Nov. 29, 2019
(86) PCT No.: PCT/JP2019/046914

§ 371 Date: May 27, 2022

(51) Int. Cl. G06Q 10/06

(52) U.S. Cl. CPC G06Q 10/06398; G06Q 10/06395

(57) ABSTRACT

A sales talent development support system includes: a storage that stores sales task information, sales skill information, and sales result expectation value in association with each other; a salesperson information reception unit, which receives an input of execution task information and a sales result achievement value; a sales result determination unit, which determines whether the sales result achievement value has reached the sales result expectation value; an execution task determination unit, which determines whether the execution task information satisfies the sales task information needed to achieve the sales result expectation value that is compared; a sales skill identification unit, which identifies sales skills needed to execute lacked sales tasks; and a sales skill presentation unit, which presents the sales skills specified by the sales skill identification unit.

### TECHNICAL FIELD

This disclosure relates to a sales talent development support system, a sales talent development support method, and a sales talent development support program.

### BACKGROUND

Systems that support the sales activities of companies are known. For example, Japanese Laid-Open Patent Publication No. 2010-271809 discloses a system that evaluates the number of times a phrase is used in response contents of a salesperson and the contract rate, and uses these information in the sales skill improvement training.

However, the skills needed for the sales activities are not limited to the response contents but may include a variety of activities such as identifying needs, and making proposals to customers, for example. A system that evaluates whether a salesperson possesses these various sales skills by referring to the results achieved by the salesperson and suggests acquisition of the needed skills has been needed.

Therefore, it could be helpful to provide a sales talent development support system capable of evaluating the sales skills possessed by a salesperson and suggesting the acquisition of needed skills while referring to the results achieved by the salesperson.

### SUMMARY

We thus provide a sales talent development support system including: a storage, which associates and stores a plurality of pieces of sales task information indicating contents of sales tasks to be executed by a salesperson in a sales activity of a company, a plurality of pieces of sales skill information indicating contents of sales skills needed to execute the sales tasks, and a sales result expectation value indicating a value of a sales result expected to be achieved by executing at least one of the sales tasks; a salesperson information reception unit, which receives input of execution task information indicating contents of actions actually executed by the salesperson in the sales activity and a sales result achievement value indicating a value of a sales result achieved by the salesperson; a sales result determination unit, which determines whether the sales result achievement value has reached the sales result expectation value; an execution task determination unit, which determines whether the execution task information satisfies the sales task information needed to achieve the sales result expectation value compared by the sales result determination unit if the sales result achievement value has not reached the sales result expectation value; a sales skill identification unit, which identifies, if the execution task information does not satisfy the sales task information needed to achieve the compared sales result expectation value, the sales skills needed to execute the sales tasks that are lacked; and a sales skill presentation unit, which presents the sales skills identified by the sales skill identification unit.

In addition, the storage may further store training information indicating contents of training needed to acquire the sales skills needed in the sales activity of the company, and the sales skill presentation unit may present, when presenting contents of the sales skills identified by the sales skill identification unit, the training information corresponding to the training needed to acquire the sales skills as well.

The system may further include an external training provision unit, which acquires contents of training needed to acquire the sales skills identified by the sales skill identification unit from a training provider outside the company and provides the salesperson with the acquired contents.

The system may further include a skill acquisition determination unit, which determines whether the salesperson has acquired the sales skills identified by the sales skill identification unit.

The system may further include a task execution determination unit, which determines whether the salesperson has executed sales tasks that is capable of being executed by possessing the sales skills identified by the sales skill identification unit.

In addition, a sales talent development support method causes a computer to execute: a storage step for associating and storing a plurality of pieces of sales task information indicating contents of sales tasks to be executed by a salesperson in a sales activity of a company, a plurality of pieces of sales skill information indicating contents of sales skills needed to execute the sales tasks, and a sales result expectation value indicating a value of a sales result expected to be achieved by executing at least one of the sales tasks; a salesperson information reception step for receiving input of execution task information indicating contents of actions actually executed by the salesperson in the sales activity and a sales result achievement value indicating a value of a sales result achieved by the salesperson; a sales result determination step for determining whether the sales result achievement value has reached the sales result expectation value; an execution task determination step for determining whether the execution task information satisfies the sales task information needed to achieve the sales result expectation value compared in the sales result determination step if the sales result achievement value has not reached the sales result expectation value; a sales skill identification step for identifying, if the execution task information does not satisfy the sales task information needed to achieve the compared sales result expectation value, the sales skills needed to execute the sales tasks that are lacked; and a sales skill presentation step for presenting contents of the sales skills identified in the sales skill identification step.

In addition, a sales talent development support program causes a computer to embody: a storage function, which associates and stores a plurality of pieces of sales task information indicating contents of sales tasks to be executed by a salesperson in a sales activity of a company, a plurality of pieces of sales skill information indicating contents of sales skills needed to execute the sales tasks, and a sales result expectation value indicating a value of a sales result expected to be achieved by executing at least one of the sales tasks; a salesperson information reception function, which receives input of execution task information indicating contents of actions actually executed by the salesperson in the sales activity and a sales result achievement value indicating a value of a sales result achieved by the salesperson; a sales result determination function, which determines whether the sales result achievement value has reached the sales result expectation value; an execution task determination function, which determines whether the execution task information satisfies the sales task information needed to achieve the sales result expectation value compared by the sales result determination function if the sales result achievement value has not reached the sales result expectation value; a sales skill identification function, which identifies, if the execution task information does not satisfy the sales task information needed to achieve the compared sales result expectation value, the sales skills needed to execute the sales tasks that are lacked; and a sales skill presentation function, which presents contents of the sales skills identified by the sales skill identification function.

The sales talent development support system is capable of identifying the sales tasks that have not been executed when the sales result achievement value has not reached the sales result expectation value as a predetermined target value, and identifying the sales skills needed to execute the sales tasks.

The sales skill presentation unit presents the sales skills that the salesperson lacks to allow the salesperson to recognize the sales skills that she/he needs to acquire in the future to achieve the target value of the sales activities. This allows the system to evaluate the sales skills possessed by the salesperson and suggest acquisition of the needed skills while referring to the results achieved by the salesperson.

### BRIEF DESCRIPTION OF THE DRAWINGS

Features, advantages, and technical and industrial significance of examples will be described below with reference to the accompanying drawings, in which like numerals denote like elements.

FIG. 1 is a schematic diagram illustrating a sales talent development support system and peripheral configurations of the system according to a first examples.

FIG. 2 is a diagram illustrating a concept of the sales talent development support system.

FIG. 3 is a block diagram illustrating a configuration of the sales talent development support system shown in FIG. 1.

FIG. 4 is a diagram illustrating a relationship between sales skill information and sales task information in the sales talent development support system.

FIG. 5 is a flowchart illustrating a first half of the processing flow in the sales talent development support system.

FIG. 6 is a flowchart illustrating a second half of the processing flow in the sales talent development support system.

### DETAILED DESCRIPTION

One example of our systems, methods and programs will be described with reference to the drawings.

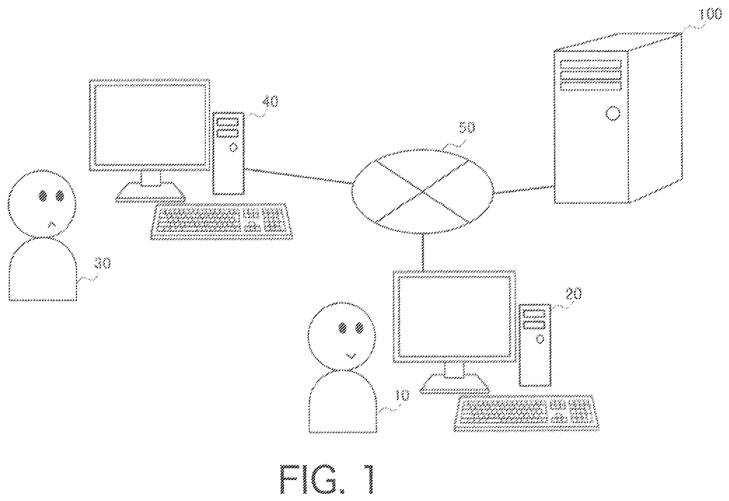

FIG. 1 is a schematic diagram illustrating a sales talent development support system 100 and peripheral configurations of the system according to a first example. The sales talent development support system 100 is directed to a system configured to support sales activities by evaluating the sales results achieved by a salesperson 10 in a company, the sales tasks executed by the salesperson 10, and the sales skills needed to execute the sales tasks.

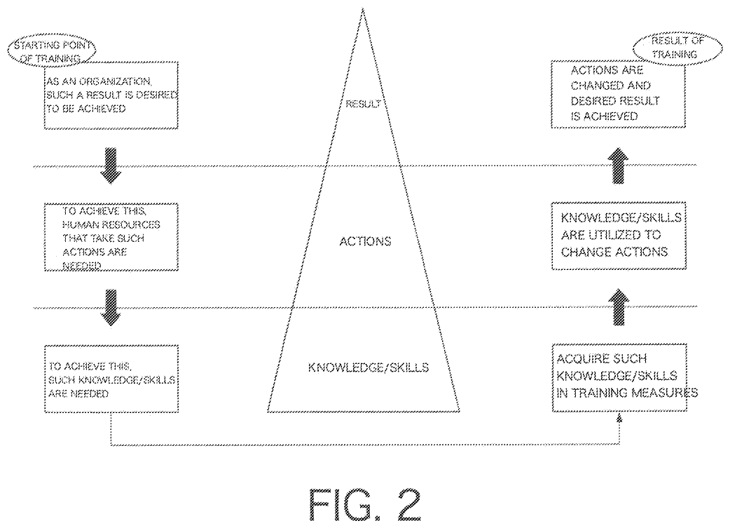

With reference to FIG. 2, the concept of the sales talent development support system 100 will be described. FIG. 2 is a diagram illustrating a concept of the sales talent development support system.

As shown in FIG. 2, the sales talent development support system is designed to train (develop) sales talent. The system assumes that actions (sales tasks) are the basis of results, and knowledge and skills (sales skills) are the basis of the actions (sales tasks).

The needed sales tasks are then identified for the sales results desired to be achieved. Further, the sales skills needed for the needed sales tasks are identified. The system seeks to cause the salesperson 10 to acquire the needed sales skills to change her/his actions (sales tasks) and change the sales results she/he is able to achieve.

As described above, the sales talent development support system is directed to a system that contributes to the talent development of the salesperson 10 by evaluating the sales skills and sales results in a full straight manner.

Specifically, the sales talent development support system 100 evaluates whether the sales results set as a target are achieved and, if not, identifies what sales tasks are lacking. The system then identifies what sales skills the salesperson 10 lacks to execute the sales tasks, and encourages her/him to acquire the sales skills. The details of the sales tasks and sales skills will be described below.

As shown in FIG. 1, the sales talent development support system 100 is connected through a network 50 to a salesperson terminal 20 and a superior terminal 40.

In this example, the salesperson 10 is directed to a person that belongs to a sales department of a company and engages in sales activities. The salesperson 10 is not limited to field members but may also include executives or managers if she/he actually conducts sales activities.

The superior 30 evaluates the sales results of the salesperson 10 and corresponds to a department head such as a chief director or a section chief that has evaluation authority. The superior 30 may include a chief clerk, a team leader, and other middle managers that evaluate subordinates while actually conducting the sales activities as well.

The salesperson terminal 20 is directed to a terminal used by the salesperson 10, and in the example shown in FIG. 1, it corresponds to a personal computer used by the salesperson 10 in her/his work. The salesperson terminal 20 is not limited to this, and may correspond to a smartphone or tablet terminal used by the salesperson 10 at work, or a variety of terminals used by the salesperson 10 for private use.

If multiple salespersons 10 are present, multiple salesperson terminals 20 will be connected to the network 50 although the form is omitted from FIG. 1.

The superior terminal 40 is directed to a terminal used by the superior 30, which is a personal computer in the illustrated example. The superior terminal 40 is not limited to this form, and may correspond to a smartphone or tablet terminal. Although omitted in FIG. 1, a plurality of superior terminals 40 may be connected to the network 50. In this example, multiple superiors 30 such as middle managers or department heads may evaluate the sales activities of the salespersons 10.

The network 50 is directed to a network for interconnecting the sales talent development support system 100 with various devices including, for example, a wireless network or a wired network.

Specifically, the network 50 may include a wireless LAN (WLAN) or a wide area network (WAN), integrated service digital networks (ISDNs), wireless LANs, long term evolution (LTE), LTE-Advanced, 4th Generation (4G), 5th generation (5G), code division multiple access (CDMA), WCDMA (registered trademark), and Ethernet (registered trademark), for example.

The network 50 is not limited to these examples, but may include, for example, the public switched telephone network (PSTN), Bluetooth (registered trademark), and Bluetooth Low Energy (registered trademark), optical communication lines, asymmetric digital subscriber line (ADSL), satellite communication networks, or any other network.

The network 50 may also include, for example, a narrow band IoT (NB-IoT) and enhanced machine type communication (eMTC). In addition, the NB-IoT and eMTC are wireless communication methods for IoT, which are low-cost, low-power, and long distance communication network.

The network 50 may also be a combination of these. The network 50 may also include a plurality of different networks combining these examples. For example, the network 50 may include a wireless network based on LTE and a wired network such as an intranet as a closed network.

The sales talent development support system 100 is directed to an information processing server that performs various processings to evaluate the achieved sales results, sales tasks, and sales skills of the salesperson 10 to support her/his sales activities.

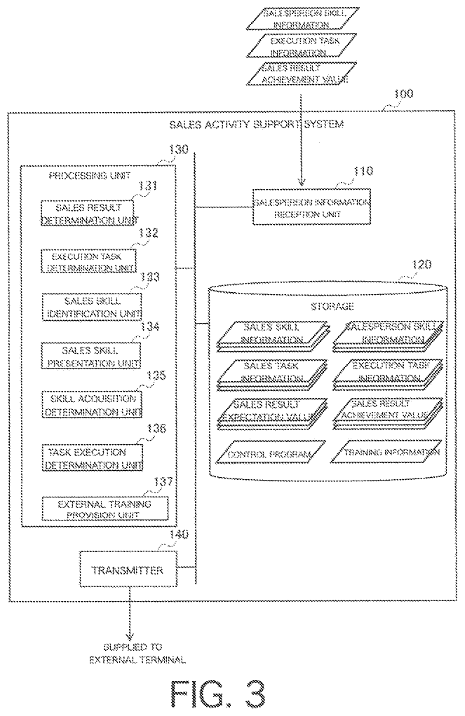

The sales talent development support system 100 may be embodied, for example, by artificial intelligence. With reference to FIG. 3, the configuration of the sales talent development support system 100 will be described in detail below. FIG. 3 is a block diagram illustrating a configuration of the sales talent development support system 100 shown in FIG. 1.

As shown in FIG. 3, the sales talent development support system 100 includes a salesperson information reception unit 110, a storage 120, a processing unit 130, and a transmitter 140.

The salesperson information reception unit 110 serves as an interface that receives various types of information on the salesperson 10 from outside via the network 50 shown in FIG. 1.

The various types of information on the salesperson 10 may include: the salesperson skill information, the execution task information, and sales result achievement values.

The salesperson skill information is directed to information that indicates for each salesperson 10 whether the salesperson 10 has each of the multiple sales skills. The superior 30 that evaluates the salesperson 10, enters the salesperson skill information through the superior terminal 40.

The execution task information is directed to information that indicates the contents of the actions (sales tasks) actually executed by the salesperson 10 in her/his sales activities. The superior 30 that evaluates the salesperson 10 enters the execution task information through the superior terminal 40. In addition, the salesperson 10 herself/himself may enter the execution task information through the salesperson terminal 20.

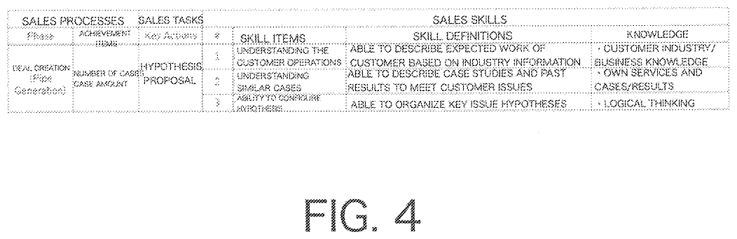

With reference to FIG. 4, a relationship between sales skill information and sales task information will be described. FIG. 4 is a diagram illustrating a relationship between sales skill information and sales task information in the sales talent development support system 100.

As shown in FIG. 4, multiple sales skills are set up to execute a single sales task. In FIG. 4, for the sales process, phases in the sales activities are specified as, for example, Planning (plan), Pipe Generation (deal creation), Deal Progress, (matter progress) and Deal Closing (matter closing). FIG. 4 merely illustrates the sales task related to “hypothetical proposal” in the phase of the Pipe Generation (deal creation).

The sales task is directed to an important action (Key Action) in the sales activities. The execution of all of the Key Actions allows certain results to be expected in the sales activities. Although FIG. 4 merely illustrates the sales task related to the “hypothetical proposal,” actually, the Pipe Generation includes multiple sales tasks.

The sales skills refer to the skills needed to smoothly execute the sales tasks. In FIG. 4, the skill items are listed in the skill column, and the specific details of the relevant sales skill, which is the criterion for determining whether a person has the relevant sales skill, are listed in the skill definition column. Further, the rightmost column defines the knowledge needed to acquire the sales skills.

In addition, the “number of matters” and “case amount” in the Achievement Items column correspond to the sales result expectation values described below.

For example, to execute the sales task of the “hypothetical proposal,” the sales skills of “understanding the customer operations,” “understanding similar cases,” and “ability to configure hypotheses” are needed. The specifics of the sales skills are listed in the skill definitions column. A considerable number of such sales tasks and sales skills are set in advance, including but not limited to those illustrated in the example.

The sales result achievement value is directed to information indicating the value of sales results achieved by the salesperson 10. The sales result achievement values are entered by the superior 30 that evaluates the salesperson 10 through the superior terminal 40. The sales result achievement values may be handled on the basis of numerical values such as the amount of sales, for example, or on the basis of status in the sales activities such as the number of meetings with the customers.

When the salesperson information reception unit 110 receives various data, it causes the storage 120 to store the data.

The storage 120 serves to associate and store various control programs and various data needed for the operation of the processing unit 130. The storage 120 may be embodied, for example, by various storage media such as HDD, SSD, and flash memory.

The sales talent development support system 100 stores control programs in the storage 120, and executes the analysis program to cause the processing unit 130 to perform the functions to be embodied as the sales talent development support system 100. The functions here may include a storage function, a salesperson information reception function, a sales result determination function, an execution task determination function, a sales skill identification function, and a sales skill presentation function.

The various data stored by the storage 120 may include sales task information, sales skill information, and sales result expectation values as well as the salesperson skill information, execution task information, and sales result achievement values as described above.

The sales task information is directed to information indicating the contents of sales tasks to be executed by the salesperson 10 in the sales activities of the company to achieve predetermined sales results. Generally, multiple sales tasks are set.

The sales skill information is directed to information indicating the sales skills needed to execute the sales tasks. Generally, multiple sales skills are set as those needed to execute a single sales task.

The sales result expectation values indicate the values of the sales results each expected to be achieved by executing at least one of the sales tasks. The sales result expectation values may be handled on the basis of numerical values such as the amount of sales, for example, or on the basis of status in the sales activities such as the number of meetings with the customers.

The storage 120 also stores training information. The training information is directed to information indicating the contents of the training needed to acquire the sales skills desired in the sales activities of the company.

The processing unit 130 is directed to a computer that controls the portions of the sales talent development support system 100 such as a central processing unit (CPU), a microprocessor, an ASIC, and an FPGA, for example. The processing unit 130 is not limited to these examples and may include any function that controls the portions of the sales talent development support system 100.

The processing unit 130 includes a sales result determination unit 131, an execution task determination unit 132, a sales skill identification unit 133, a sales skill presentation unit 134, a skill acquisition determination unit 135, a task execution determination unit 136, and an external training provision unit 137.

The sales result determination unit 131 determines whether the sales result achievement value has reached the sales result expectation value. That is, the sales result determination unit 131 checks whether the amount of sales, for example, achieved by the salesperson 10 in the sales activities for a certain period of time such as six months or a quarter has reached a predetermined expected value (target value) or, i.e., whether the results of the sales activities have been greater than or equal to the expected value.

The execution task determination unit 132 determines whether the execution task information satisfies all the pieces of the sales task information needed to achieve the sales result expectation value in comparison to the sales result achievement value when the sales result achievement value has not reached the sales result expectation value. When checking the sufficiency of the multiple pieces of the sales task information, the execution task determination unit 132 may determine whether essential sales tasks of high importance, especially those directly related to results, are satisfied out of the total, even if not all the sales tasks are necessarily satisfied.

That is, if all the predetermined execution tasks are executed, the predetermined sales result expectation value is achieved. In contrast, if the sales result expectation value is not achieved, any of the execution tasks is not executed. The execution task determination unit 132 identifies such execution tasks that have not been actually executed.

If the execution task information does not satisfy all the pieces of the sales task information needed to achieve the sales result expectation value compared to the sales result achievement value, the sales skill identification unit 133 identifies the sales skills needed to execute the lacked sales skills.

That is, the sales skill identification unit 133 identifies what sales skills the salesperson 10 has lacked as the reason why she/he has failed to execute the sales tasks.

The sales skill presentation unit 134 presents the sales skills identified by the sales skill identification unit 133 to the superior terminal 40 and the salesperson terminal 20.

In addition, when presenting the contents of the sales skills identified by the sales skill identification unit 133, the sales skill presentation unit 134 presents the training information corresponding to the training needed to acquire the sales skills as well.

The skill acquisition determination unit 135 determines whether the salesperson 10 has acquired the sales skills identified by the sales skill identification unit 133.

That is, the skill acquisition determination unit 135 determines whether the salesperson 10 to which the various trainings have been presented actually has acquired the sales skills that have been assumed to be acquired through the trainings afterwards. Specifically, the skill acquisition determination unit 135 checks whether new sales skills have been updated as the salesperson skill information.

The task execution determination unit 136 determines whether the salesperson 10 has executed the sales tasks that can be executed by possessing the sales skills identified by the sales skill identification unit 133.

That is, the task execution determination unit 136 checks whether the salesperson 10 has acquired new sales skills so that she/he then has actually executed the sales tasks that can be executed with the new sales skills. Specifically, the task execution determination unit 136 checks whether new execution tasks have been updated in the execution task information.

The external training provision unit 137 acquires the contents of training needed to acquire the sales skills identified by the sales skill identification unit 133 from training providers outside the company, and provides the salesperson 10 with them.

That is, the external training provision unit 137 widely acquires various training information from the outside, which is not limited to the training information stored in the storage 120 in advance, and provides the salesperson 10 with the training needed to acquire the sales skills.

The transmitter 140 corresponds to a communication interface that serves to transmit various data to the salesperson terminal 20 or the superior terminal 40.

That is, the transmitter 140 allows the salesperson 10 to check the results of the various processes performed by the functional units in the processing unit 130 described above through the salesperson terminal 20, and the superior 30 to check them through the superior terminal 40 as well.

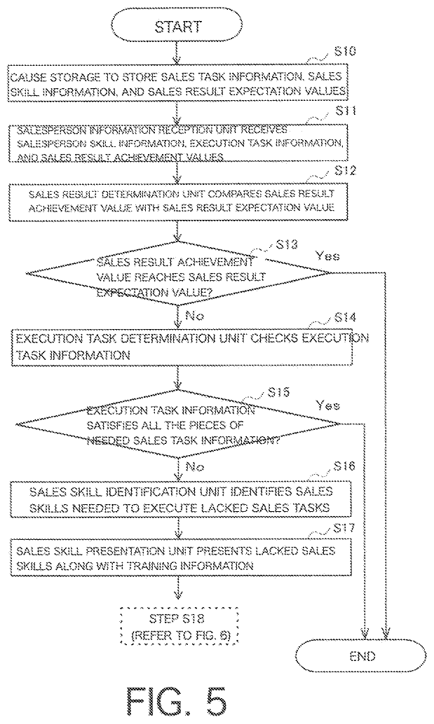

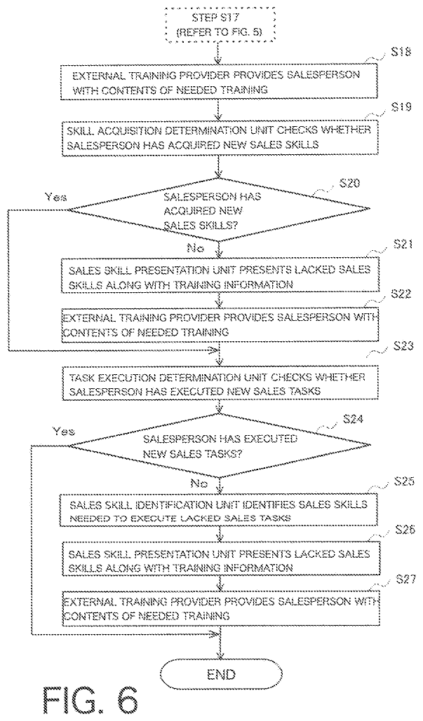

Next, with reference to FIGS. 5 and 6, the control flow of the sales talent development support system 100 will be described along with the operation screens.

FIG. 5 is a flowchart illustrating a first half of the processing flow in the sales talent development support system 100. FIG. 6 is a flowchart illustrating a second half of the processing flow in the sales talent development support system 100.

As shown in FIG. 5, first, the superior 30 causes the storage 120 to store the sales task information, sales skill information, and sales result expectation values (step S10: storage step).

In this example, the superior 30 may enter the pieces of information through the superior terminal 40, or the salesperson 10 that has had an interview with the superior 30 may enter the target values for sales results as the sales result expectation values through the salesperson terminal 20.

Next, the superior 30 enters the salesperson skill information, execution task information, and sales result achievement values through the superior terminal 40, and the salesperson information reception unit 110 receives the information (step S11: salesperson information reception step). The superior 30 evaluates the skills of the salesperson and enters the sales skills that the salesperson is deemed to possess as the salesperson skill information. The sales skills of the salesperson 10 may be entered after consultation between the superior 30 and the salesperson 10.

In addition, the superior 30 enters information on the sales tasks actually executed in the sales activities from the salesperson 10 as the execution task information. The salesperson 10 may enter the execution task information in the form of a report on her/his own sales activities.

The sales result achievement value is entered by the superior 30 after checking the amount of sales achieved by the salesperson 10.

Next, the sales result determination unit 131 compares the sales result achievement value with the sales result expectation value to determine whether the sales result achievement value has reached the sales result expectation value (step S12: sales result determination step). In this example, if the sales result expectation value and sales result achievement value are expressed in terms of numerical values such as monetary values, the amounts are compared. Then, if the sales result expectation value and sales result achievement value are expressed by status, the status entered for the sales result achievement value is checked to determine whether it corresponds to the status set for the sales result expectation value.

If the sales result achievement value exceeds the sales result expectation value (Yes in step S13), it is determined that the sales result expectation value expected in the planning stage has achieved the target value in the sales activities, and the process is completed.

In contrast, if the sales result achievement value does not exceed the sales result expectation value (No in step S13), the execution task determination unit 132 checks the execution task information (step S14: execution task determination step).

Specifically, it is determined whether the execution task information indicating the sales tasks actually executed by the salesperson 10 satisfies all the pieces of the sales task information needed to achieve the compared sales result expectation value.

That is, it is assumed that the sales result achievement value has not reached the sales result expectation value due to a fact that any of the multiple sales tasks has failed to be executed, and what sales tasks that have not actually been executed are checked. This identifies the sales tasks that have failed to be executed in the sales activities.

If the execution task information satisfies all the pieces of the needed sales task information (Yes in step S15), it is determined that there are other reasons why the sales result achievement value does not reach the sales result expectation value, and the process is completed.

In contrast, if the execution task information does not satisfy all the pieces of the needed sales task information (No in step S15), the lacked sales tasks are identified. The sales skill identification unit 133 then identifies the sales skills needed to execute the lacked sales tasks (step S16: sales skill identification step).

In this example, if multiple sales skills are needed to execute each sales task, all applicable multiple sales skills are identified.

The sales skill presentation unit 134 then presents the lacked sales skills to the superior 30 and salesperson 10 (step S17: sales skill presentation step). At this time, the sales skill presentation unit 134 also presents the training information needed to acquire the sales skills.

When the sales skills identified by the sales skill identification unit 133 are registered in the salesperson skill information, i.e., when the evaluation of the superior 30 recognizes that the salesperson 10 possesses the identified sales skills, these sales skills are deleted from the salesperson skill information even if the salesperson 10 has not actually acquired the sales skills to the extent that she/he is capable of using them in the sales activities. This allows the system to check whether the salesperson 10 has the relevant sales skills to the extent that she/he is capable of actually using them in the sales activities.

Next, the external training provision unit 137 acquires the contents of the training needed to acquire the lacked sales skills from training providers outside the company and provides the salesperson 10 with them (step S18: external training provision step).

This process may be performed only when the corresponding training information is not stored in the storage 120. This is the first round of evaluation of the results of the sales activities by the sales talent development support system 100. Next, the second round of evaluation of the salesperson 10 by the sales talent development support system 100 after the salesperson 10 acquires the sales skills that the salesperson 10 has lacked as described above will be described.

Next, after a certain period of time, the skill acquisition determination unit 135 checks whether the salesperson 10 has acquired new sales skills (step S19: skill acquisition determination step).

This process is preferably performed after the superior 30 has again updated the salesperson skill information for the salesperson 10. If the salesperson 10 has acquired new sales skills (lacked sales skills) (Yes in step S20), the process proceeds to step S23 described below.

In contrast, if the salesperson 10 has not acquired the new sales skills (the lacked sales skills) (No in step S20), the sales skill presentation unit 134 again presents the lacked sales skills along with the training information (step S21: sales skill presentation step).

In addition, the external training provision unit 137 provides the salesperson 10 with the contents of the needed training (step S22: external training provision step).

After the sales activities for a certain period of time have been completed, the task execution determination unit 136 checks whether the salesperson 10 has executed new sales tasks (step S23: task execution determination step).

In this example, the sales tasks checked by the task execution determination unit 136 are directed to sales tasks that may be executed by the sales skills that the salesperson 10 would have newly acquired. If the salesperson 10 has executed the new sales tasks (Yes in step S24), the process by the sales talent development support system 100 is completed.

In contrast, if the salesperson 10 has not executed any new sales task (No in step S24), the sales skill identification unit 133 again identifies the sales skills needed to execute the lacked sales tasks (step S25: sales skill identification step).

After the lacked sales skills are identified, the sales skill presentation unit 134 presents the lacked sales skills along with the training information to the salesperson 10 (step S26: sales skill presentation step). In addition, the external training provision unit 137 provides the contents of the needed training to the salesperson 10 (step S27: external training provision step).

This process is repeated to repeatedly facilitate the salesperson 10 to acquire the sales skills she/he lacks. The above process flow illustrates an example only, and the order of processing by the functional units may be optionally changed without departing from the spirits of this disclosure.

As described above, according to the sales talent development support system 100 of this example, when the sales result achievement value does not reach the sales result expectation value as a predetermined target value, the sales tasks that have not been executed may be identified and the sales skills needed to execute the sales tasks may be identified as well.

The sales skill presentation unit 134 presents the lacked sales skills to the salesperson 10, allowing the salesperson 10 to recognize the sales skills that she/he will need to acquire to achieve the target values of the sales activities. This evaluates the sales skills possessed by the salesperson 10 with reference to the results achieved by the salesperson 10, and suggests that she/he may acquire the needed skills.

In addition, when the storage 120 stores the training information and the sales skill presentation unit 134 presents the contents of the sales skills identified by the sales skill identification unit 133, the sales skill presentation unit 134 presents the training information corresponding to the training needed to acquire the sales skills as well.

This allows the salesperson 10 to not only recognize the sales skills she/he lacks but also to recognize what type of training will cause her/him to acquire the sales skills. This further contributes to the improvement of the sales skills of the salesperson 10.

In addition, the external training provision unit 137 acquires the contents of the needed training from the training providers outside the company to acquire the lacked sales skills, and provides the salesperson 10 with them.

This allows a wide variety of training contents to be gathered from outside the company and provided to the salesperson 10. This in turn provides the salesperson 10 with training that fits her/him so that the acquisition of the sales skills may be more efficient.

In addition, the skill acquisition determination unit 135 determines whether the sales skills identified by the sales skill identification unit 133 have been acquired by the salesperson 10. This allows the system to check whether the salesperson 10 that has recognized to lack the sales skills has actually subsequently acquired the lacked sales skills.

This reliably facilitates the salesperson 10 to acquire the lacked sales skills.

In addition, the task execution determination unit 136 determines whether the salesperson 10 has actually executed the sales tasks that she/he newly becomes able to execute by acquiring the lacked sales skills. This allows not only whether the lacked sales skills have been acquired to be checked but also whether the needed sales tasks have been executed using the acquired sales skills to be checked.

This allows the system to check whether the sales tasks that need to be executed have been executed to achieve the sales result expectation value as a target value.

The system of the above example is not limited to the above example, and may be embodied by other methods. Various examples of variations will be described below.

For example, the program of the above example may be provided as stored in a computer-readable storage medium. A storage medium is directed to a “non-transitory tangible medium” capable of storing programs. The storage medium may include any suitable storage medium such as an HDD or SDD, or a suitable combination of two or more of these.

The storage medium may be volatile, nonvolatile, or a combination of volatile and nonvolatile. The storage medium is not limited to these examples and may be any device or medium if it is capable of storing programs.

The sales talent development support system 100 is capable of embodying the functions illustrated in the example by reading programs stored in a storage medium and executing the read programs, for example. The programs may be provided through any transmission medium (such as communication network and broadcast wave) to the sales talent development support system 100.

The sales talent development support system 100 may, for example, be configured to embody the functions of the multiple functional units illustrated in the examples by executing programs downloaded via the Internet or other means.

The programs may also be implemented using, for example, scripting languages such as ActionScript, and JavaScript (registered trademark), object-oriented programming languages such as Objective-C, and Java (registered trademark), and markup languages such as HTML5.

At least a part of the processing in the sales talent development support system 100 may be embodied by cloud computing configured by one or more computers.

Each of the functional units of the sales talent development support system 100 may be embodied by one or more circuits that embody the functions illustrated in the above examples, or multiple functional units may be embodied by a single circuit.

Although the examples have been described on the basis of various drawings and examples, those skilled in the art will be able to make various changes and modifications on the basis of this disclosure. Accordingly, these variations and modifications are included within the scope of this disclosure.

For example, the functions included in each method and step, for example, may be rearranged to be avoided to be logically inconsistent, and multiple methods and steps may be integrated or divided. The configurations shown in the examples above may be combined as appropriate.

1-7. (canceled)

8. A sales talent development support system comprising:
a storage that associates and stores a plurality of pieces of sales task information indicating contents of sales tasks to be executed by a salesperson in a sales activity of a company, a plurality of pieces of sales skill information indicating contents of sales skills needed to execute the sales tasks, and a sales result expectation value indicating a value of a sales result expected to be achieved by executing at least one of the sales tasks;
a salesperson information reception unit that receives input of execution task information indicating contents of actions actually executed by the salesperson in the sales activity and a sales result achievement value indicating a value of a sales result achieved by the salesperson;
a sales result determination unit that determines whether the sales result achievement value has reached the sales result expectation value;
an execution task determination unit that determines whether the execution task information satisfies the sales task information needed to achieve the sales result expectation value compared by the sales result determination unit if the sales result achievement value has not reached the sales result expectation value;
a sales skill identification unit that identifies, if the execution task information does not satisfy the sales task information needed to achieve the compared sales result expectation value, the sales skills needed to execute the sales tasks that are lacked; and
a sales skill presentation unit that presents the sales skills identified by the sales skill identification unit.

9. The system according to claim 8, wherein the storage further stores training information indicating contents of training needed to acquire the sales skills needed in the sales activity of the company, and
the sales skill presentation unit presents, when presenting contents of the sales skills identified by the sales skill identification unit, the training information corresponding to the training needed to acquire the sales skills as well.

10. The system according to claim 8, further comprising an external training provision unit that acquires contents of training needed to acquire the sales skills identified by the sales skill identification unit from a training provider outside the company and provides the salesperson with the acquired contents.

11. The system according to claim 8, further comprising a skill acquisition determination unit that determines whether the salesperson has acquired the sales skills identified by the sales skill identification unit.

12. The system according to claim 11, further comprising a task execution determination unit that determines whether the salesperson has executed sales tasks capable of being executed by possessing the sales skills identified by the sales skill identification unit.

13. A sales talent development support method causing a computer to execute:
a storage step for associating and storing a plurality of pieces of sales task information indicating contents of sales tasks to be executed by a salesperson in a sales activity of a company, a plurality of pieces of sales skill information indicating contents of sales skills needed to execute the sales tasks, and a sales result expectation value indicating a value of a sales result expected to be achieved by executing at least one of the sales tasks;
a salesperson information reception step that receives input of execution task information indicating contents of actions actually executed by the salesperson in the sales activity and a sales result achievement value indicating a value of a sales result achieved by the salesperson;
a sales result determination step that determines whether the sales result achievement value has reached the sales result expectation value;
an execution task determination step that determines whether the execution task information satisfies the sales task information needed to achieve the sales result expectation value compared in the sales result determination step if the sales result achievement value has not reached the sales result expectation value;
a sales skill identification step that identifies, if the execution task information does not satisfy the sales task information needed to achieve the compared sales result expectation value, the sales skills needed to execute the sales tasks that are lacked; and
a sales skill presentation step that presents contents of the sales skills identified in the sales skill identification step.

14. A non-transitory computer readable medium storing therein a sales talent development support program causing a computer to embody:
a storage function that associates and stores a plurality of pieces of sales task information indicating contents of sales tasks to be executed by a salesperson in a sales activity of a company, a plurality of pieces of sales skill information indicating contents of sales skills needed to execute the sales tasks, and a sales result expectation value indicating a value of a sales result expected to be achieved by executing at least one of the sales tasks;
a salesperson information reception function that receives input of execution task information indicating contents of actions actually executed by the salesperson in the sales activity and a sales result achievement value indicating a value of a sales result achieved by the salesperson;
a sales result determination function that determines whether the sales result achievement value has reached the sales result expectation value;
an execution task determination function that determines whether the execution task information satisfies the sales task information needed to achieve the sales result expectation value compared by the sales result determination function if the sales result achievement value has not reached the sales result expectation value;
a sales skill identification function that identifies, if the execution task information does not satisfy the sales task information needed to achieve the compared sales result expectation value, the sales skills needed to execute the sales tasks that are lacked; and
a sales skill presentation function that presents contents of the sales skills identified by the sales skill identification function.

15. The system according to claim 9, further comprising an external training provision unit that acquires contents of training needed to acquire the sales skills identified by the sales skill identification unit from a training provider outside the company and provides the salesperson with the acquired contents.

16. The system according to claim 9, further comprising a skill acquisition determination unit that determines whether the salesperson has acquired the sales skills identified by the sales skill identification unit.

17. The system according to claim 10, further comprising a skill acquisition determination unit that determines whether the salesperson has acquired the sales skills identified by the sales skill identification unit.

18. The system according to claim 15, further comprising a skill acquisition determination unit that determines whether the salesperson has acquired the sales skills identified by the sales skill identification unit.
